(19) United States
(12) Patent Application Publication
(10) Pub. No.: US 2009/0168835 A1
(43) Pub. Date: Jul. 2, 2009

(54) Portable IR Thermometer Having USB-HID Interface

(76) Inventors: Thomas Heinke, Santa Cruz, CA (US); Li Jun Lu, Beijing (CN)

Correspondence Address: NELSON MULLINS RILEY & SCARBOROUGH, LLP, 1320 MAIN STREET, 17TH FLOOR, COLUMBIA, SC, 29201, US

(21) Appl. No.: 11/966,574

(22) Filed: Dec. 28, 2007

(51) Int. Cl. G01J 5/00

(52) U.S. Cl. 374/121; 702/135

(57) ABSTRACT

A portable noncontact thermometer comprising a hand-held housing defining an aperture for ingress of incident thermal energy from a target location. A thermometer module including a noncontact thermal energy detector is also provided. The thermometer module further includes at least one microcontroller operative to interpret electrical signals derived from an output of the noncontact thermal energy detector so as to determine temperature at the target location. A USB-HID communication interface is operative to permit electrical communication between the microcontroller(s) and a remote computer. A display device, fixed with respect to the housing, is also provided.

### BACKGROUND OF THE INVENTION

The present invention relates generally to portable IR thermometers. More particularly, the invention relates to a portable IR thermometer having a USB-HID interface for communication with a common personal computer (PC) in an easily used plug and play manner.

Portable infrared (IR) thermometers allow a user to ascertain the temperature of a remote target using a point and click technique. These instruments are commonly utilized for purposes ranging from automotive diagnostics to food safety. In the past, such instruments have been adapted for connection to a PC so that measured data could be downloaded to the PC via serial connection. In some cases, routes and emissivity data could be uploaded from the PC to the instrument.

Various details regarding the construction and operation of noncontact thermometers may be discerned from U.S. Pat. Nos. 4,634,294, 5,640,015 and 6,234,669, each of which is incorporated herein by reference in its entirety.

### SUMMARY OF THE INVENTION

According to one aspect, the present invention provides a portable noncontact thermometer comprising a hand-held housing defining an aperture for ingress of incident thermal energy from a target location. A thermometer module including a noncontact thermal energy detector is also provided. The thermometer module further includes at least one microcontroller operative to interpret electrical signals derived from an output of the noncontact thermal energy detector so as to determine temperature at the target location. A USB-HID communication interface is operative to permit electrical communication between the microcontroller(s) and a remote computer. A display device, fixed with respect to the housing, is also provided.

In some exemplary embodiments, the communication interface is capable of downloading information from the microcontroller(s) and uploading information to the microcontroller(s). Preferably, the communication interface also permits reprogramming of the microcontroller. Oftentimes, the at least one microcontroller may comprise a main microcontroller and an ADC microcontroller in communication with each other. The ADC microcontroller in such embodiments may be reprogrammed via the main microcontroller. The noncontact thermometer may further comprise a mini-USB port located on the housing and electrically connected to the communication interface.

According to another aspect, the present invention provides a system comprising a portable noncontact thermometer having a USB-HID communication interface. The communication interface of the noncontact thermometer is operative to convert In and Out reports pursuant to HID protocol. A remote computer having an operating system running a USB-HID driver so as to communicate with the thermometer via the communication interface is also provided. Preferably, the system will comprise software running on the computer for downloading temperature information from the noncontact thermometer to the computer and/or uploading emissivity data from the computer to the noncontact thermometer. The communication interface of the noncontact thermometer may be operative to communicate with the remote computer via a wired connection.

Additional aspects of the present invention, including various combinations and subcombinations of the disclosed elements, will be apparent from the remainder of the specification.

### BRIEF DESCRIPTION OF THE DRAWINGS

A full and enabling disclosure of the present invention, including the best mode thereof, to one of ordinary skill in the art, is set forth more particularly in the remainder of the specification, including reference to the accompanying drawings, in which:

FIG. 1 is a perspective view of a portable IR thermometer constructed in accordance with the present invention;

FIG. 2 is a rear view of the thermometer of FIG. 1 showing the graphical display;

FIG. 3 is a diagrammatic representation showing certain internal components of the thermometer of FIG. 1;

FIG. 4 is a diagrammatic representation of the various microcontrollers installed in the thermometer of FIG. 1 according to a preferred embodiment;

FIG. 5 shows a personal computer connected to the thermometer of FIG. 1 via the USB-HID connection;

FIG. 6 is an enlarged view showing the USB connector port of the thermometer shown in FIG. 1;

FIG. 7 is a diagrammatic representation showing the Out report protocol; and

FIG. 8 is a diagrammatic representation showing the In report protocol at command level.

Repeat use of reference characters in the present specification and drawings is intended to represent same or analogous features or elements of the invention.

### DETAILED DESCRIPTION OF PREFERRED EMBODIMENTS

It is to be understood by one of ordinary skill in the art that the present discussion is a description of exemplary embodiments only, and is not intended as limiting the broader aspects of the present invention, which broader aspects are embodied in the exemplary constructions.

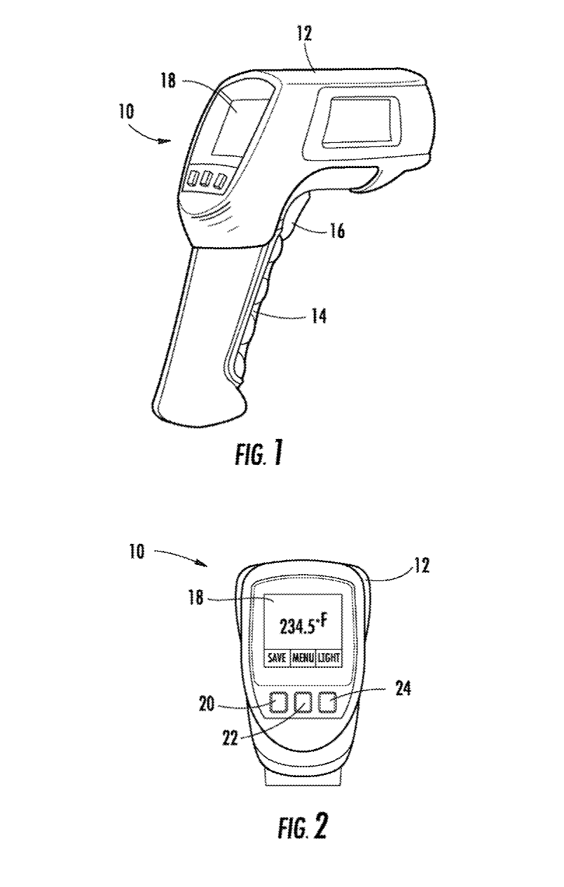

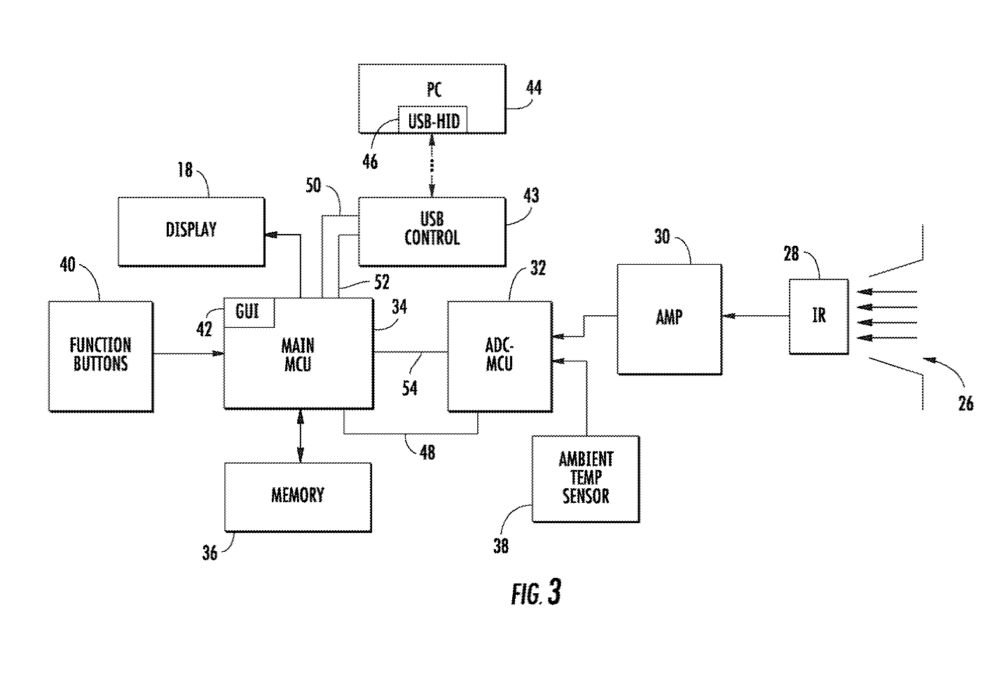

FIGS. 1 and 2 illustrate an exemplary hand-held thermometer 10 in accordance with principles of the present invention. Thermometer 10 includes an internal detector which collects energy radiated from a selected target. The energy, typically in the form of infrared (IR) radiation, is isolated and focused on the detector. The detector converts the energy into an electrical signal which is then internally processed to yield a temperature value.

As shown, thermometer 10 includes a housing 12 in which various internal components are located. While any suitable material can be utilized, housing 12 is preferably formed of a rigid high impact plastic material. As shown, housing 12 includes a handle 14 on which a trigger 16 is located. Activating trigger 16 puts the thermometer in a “scan” (or active measurement) mode. A laser diode may be provided to project a dot of light forward of the thermometer to facilitate aiming.

As indicated at 18, a graphical display device is preferably located at the rear of thermometer 10. In this case, a variety of information is shown on display device 18, including a reading of the target temperature. The target temperature (234.5° F. in FIG. 2) is preferably shown in large font in the center of the screen. Various functions of thermometer 10 are controlled by buttons 20, 22 and 24.

Preferably, thermometer 10 is configured to implement a graphical user interface (GUI) on display device 18. As shown in FIG. 2, for example, three tabs are located at the bottom of the screen in regions corresponding to buttons 20, 22 and 24, respectively. In this case, the respective tabs contain the words “Save,” “Menu” and “Light” as indicators of the function that may be performed by pressing the corresponding button. These functions may change depending on where a particular screen appears in the GUI menu tree. Various icons may also be displayed on the screen.

Certain internal components of thermometer 10 will be explained with reference to FIG. 3. Thermal energy from a selected target passes through an aperture 26 defined in housing 12, where it is directed by optics to an IR detector 28. The output of detector 28 is fed to an amplifier 30, and then to analog-to-digital converter (ADC) 32. In this case, ADC 32 is implemented using a microcontroller having a high-resolution A/D converter. The resulting digital signal from ADC 32 is then fed to main microcontroller (MCU) 34. Microcontroller 34 utilizes preprogrammed algorithms to convert the digital detector data into temperature information. A memory 36 (which may be internal to microcontroller 34) stores temperature information, along with firmware and other information (such as emissivity) utilized during operation. Detector 28 along with its associated circuitry (e.g., amplifier 30, ADC 32, main microcontroller 34 and memory 36) can be thought of collectively as a thermometer module (whether or not they form a single physical unit). In some embodiments, the thermometer module may further include an ambient temperature sensor 38. The function buttons 20, 22 and 24 are collectively indicated at 40.

As shown, display device 18 is in electrical communication with microcontroller 34. Preferably, display device 18 may be configured as a dot matrix or other suitable graphical display which implements the GUI. For example, display device 18 may be a 98×96 pixel LCD dot matrix display in some presently preferred embodiments. As a result, complex functions can be implemented with a minimum of control buttons and the user can be guided towards selecting functions and inputting parameters to the thermometer. In addition, the graphical display allows for flexible display of data and inputs, and can be customized for language, font size and the like. Different operating modes can also have different screen appearances. In this embodiment, the GUI is run on main microcontroller 34 (as indicated at 42).

It is desirable for a noncontact thermometer to have a connection to a PC so that data can be transferred between the instrument and the PC. In this case, a controller 43 installed in thermometer 10 permits communication with a common PC 44 using a driver already included within the PC's operating system. In particular, PCs running the common Windows operating system (since at least Windows 98) include a driver (schematically indicated at 46) for communicating with a Human Interface Device (HID), such as a keyboard or mouse, using the PC's universal serial bus (USB). In accordance with the present invention, it has been found that USB-HID protocol may be utilized with a noncontact thermometer instrument for “plug and play” convenience and ease of use. The USB-HID interface permits download of measured data, as well as upload of routes and emissivity information. Updates to the instrument's firmware and calibration can also be easily accomplished in the field.

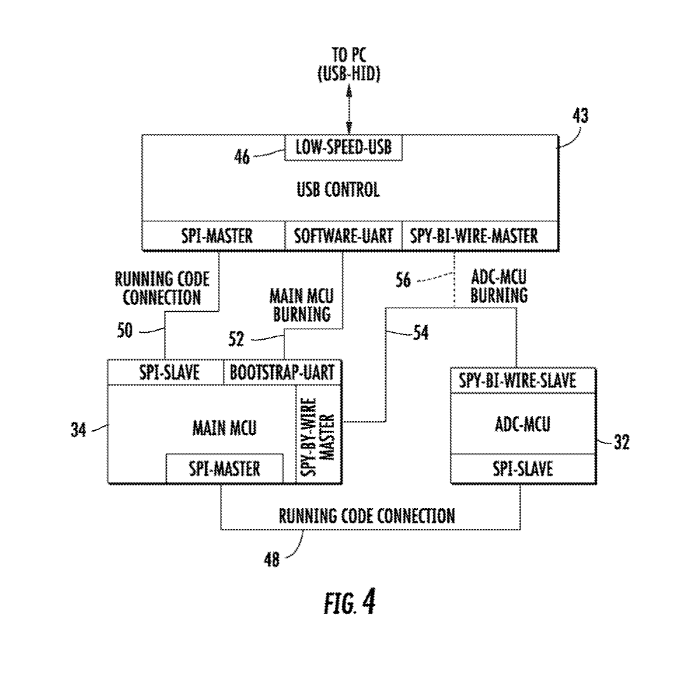

Referring now also to FIG. 4, certain additional aspects of the communication interface can be most easily explained. While embodiments are contemplated in which a single microcontroller fulfills all functional needs of the instrument, the present invention utilizes three microcontrollers 32, 34 and 43. As indicated at 46, USB microcontroller 43 includes a hardware USB interface or a USB interface implemented in software. In particular, the interface functions to provide “In” or “Out” reports by way of data exchange in the manner used by USB-HID interfaces. In this case, for example, USB controller 43 may be a CY7C63813 controller available from Cypress Semiconductors.

As noted above, ADC 32 may take the form of a microcontroller having a high resolution A/D converter. One chip suitable for this purpose is MSP430F20x3 available from Texas Instruments. While this device has an excellent A/D converter, it has limited onboard memory. Additional memory, however, may be desirable in instrument 10 to implement the GUI, as well as a sophisticated temperature calculation algorithm, etc. This additional memory and processing capability may be provided by main microcontroller 34, which may be a MSP430F1491 chip in some exemplary embodiments. This device is also available from Texas Instruments.

During normal operations, digital data produced by ADC 32 is fed to main microcontroller 34 along line 48. In this embodiment, main microcontroller 34 implements a SPI master interface, whereas a SPI slave interface is implemented on ADC 32. Similarly, data transfer between USB controller 43 and main microcontroller 34 occurs along line 50. In this regard, USB controller 43 implements a SPI master interface, whereas a SPI slave interface is implemented on main microcontroller 34. Thus, temperature data as calculated by main microcontroller 34 may be provided to USB controller 43 along line 50 for transfer to the remote computer. Likewise, route information and emissivity tables can be transferred from the PC to main microcontroller 34 along line 50.

Flash memory in ADC 32 and main microcontroller 34 may be reprogrammed using the USB-HID interface. In this case, for example, controller 43 runs software implementing a universal asynchronous receiver transmitter (UART) which is in communication with a “bootstrap” (i.e., hardware) UART of main microcontroller 34 via line 52. This line may be utilized to replace firmware and calibration data in the flash memory of main microcontroller 34. If this flash memory requires special protocols to be programmed, then the USB-HID controller implements the required protocols and converts the “In” and “Out” reports into the datastream required by the flash ROM programming protocols. For example, new firmware can be provided for debugging purposes, as well as to add additional functions to the instrument.

In this exemplary case, ADC 32 is not equipped with a UART interface, so it may be reprogrammed using a “spy-bi-wire” interface. In one preferred embodiment, for example, a spy-bi-wire master interface is implemented (such as by software) on main microcontroller 34 which communicates with a spy-bi-wire slave interface (via line 54) implemented on ADC 32. In this manner, main microcontroller 34 functions as an intermediary between USB controller 43 and ADC 32 for programming purposes. Alternatively, a spy-bi-wire master interface may be implemented on USB controller 43, which communicates directly with the spy-bi-wire slave interface of ADC 32, as indicated at 56.

In the illustrated embodiments, in which main microcontroller 34 functions as a programming intermediary, the following steps may be implemented during the reprogramming process: (1) Existing firmware in main microcontroller 34 is deleted. (2) The firmware in main microcontroller 34 is then reprogrammed via USB controller 43 so that main microcontroller 34 can be used to reprogram ADC 32. (3) ADC 32 is then reprogrammed. (4) Next, the original (or updated) firmware in main microcontroller 34 is replaced.

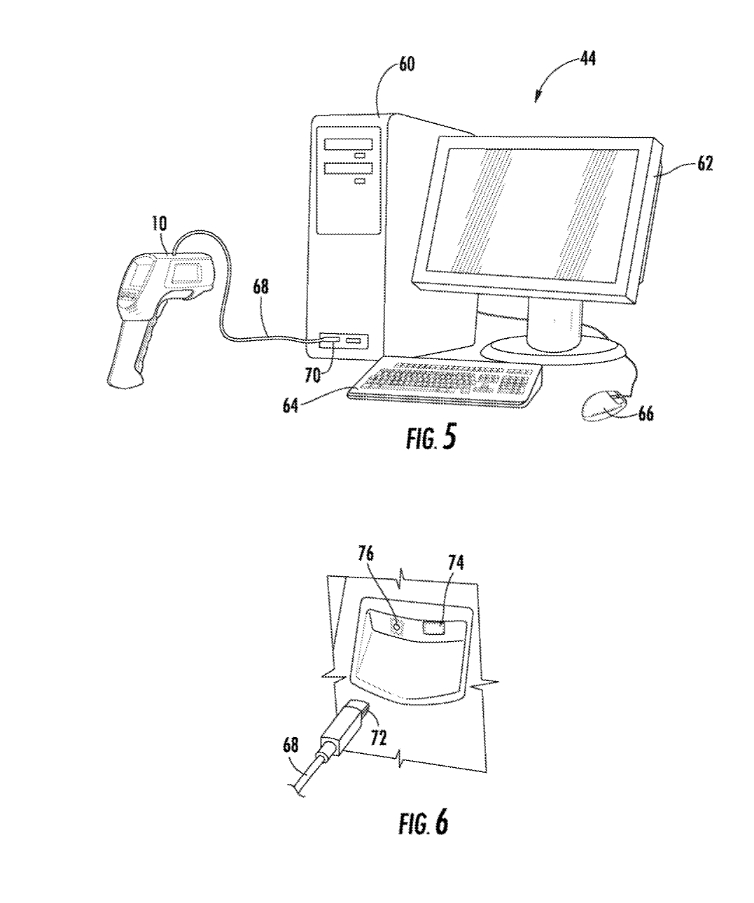

FIG. 5 shows thermometer 10 in electrical communication with a conventional personal computer 44. As one skilled in the art will appreciate, the term “computer” as used herein is not limited to a traditional desktop or laptop personal computer. Instead, “computer” is included to cover other devices, such as various personal digital assistants (PDAs), that may be capable of performing the described functionality. In this embodiment, however, computer 44 is a traditional desktop personal computer having a main housing 60 containing processing electronics, disk drives and the like. A suitable computer display 62, in this case an LCD flat screen display, is also provided. The user interacts with computer 44 using keyboard 64 and mouse 66 in the conventional manner.

The invention contemplates various techniques for providing a data link between thermometer 10 and computer 44, such as various wireless communication protocols. In the illustrated embodiment, however, electrical communication between thermometer 10 and computer 44 is accomplished using a typical serial cable 68. Cable 68 includes universal serial bus (USB) connectors at each end, one of which plugs into a corresponding port on the front of housing 60 (as indicated at 70).

As can be most clearly seen in FIG. 6, the other connector 72 is configured as a mini-USB connector. Connector 72 is inserted into a corresponding port 74 located on the top of thermometer 10. In this embodiment, a receptacle 76 is located adjacent to mini-USB port 74 for connecting a thermocouple probe for contact measurements. Computer 44 preferably includes application software which creates a user interface for displaying temperature data, logged data sets, allows editing routes and emissivity tables, and supports firmware and calibration data updates in the field. The PC application converts the data streams, required for such functions, into “In” and “Out” reports, which are used for data exchange pursuant to USB-HID protocol.

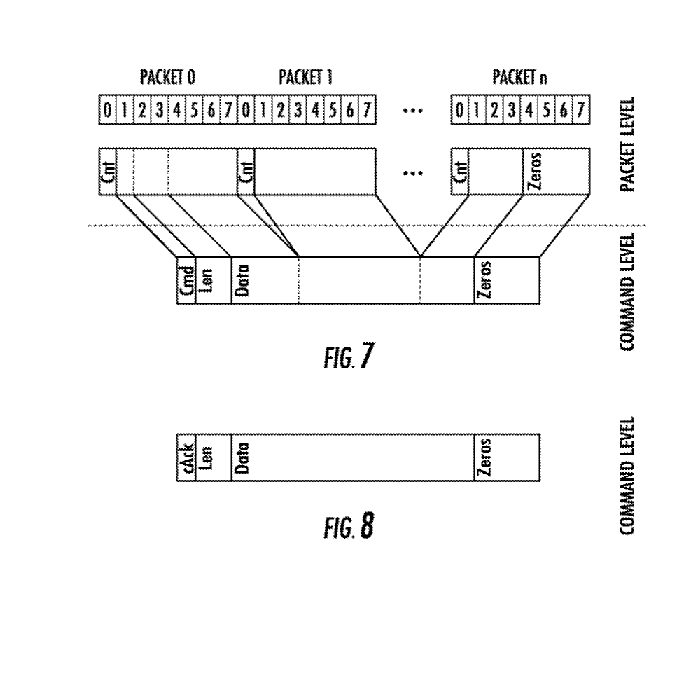

FIGS. 7 and 8 show the format of the “In” and “Out” reports in accordance with a preferred embodiment. All data transfers are in binary.

### Host to Device Data Transfer

The host sends command and data to the device.

Data transferring from the host to the device is through USB Control.

Out Report (FIG. 7)

A transfer reside in one or more USB Data Packet. According to USB Low Speed specification, each Data Packet is 8-byte long.

As shown in FIG. 7, at Packet Level each packet contains a Cnt.

At Command Level, each transfer has Cmd, Len, Data, and Zeros. At Command Level, a transfer can be of any length.

Packet Level

| Cnt | 1 byte | Bit 7 | Reset |
|---|---|---|---|
| | | | 0 Continued packet to the previous packet in a |
| | | | transfer. |
| | | | 1 First packet in a transfer |
| | | Bit 6-0 | 7-bit counter. Increases by one for each packet |
| | | | and wraps to 0. In this way, a lost packet can |
| | | | be detected. |
| | | | A discontinuous value indicates a transfer error. |
| | | | 0-127 |

Command Level

| | | |
|---|---|---|
| Cmd | 1 bytes | Command code. 1~127. 0 is reserved for heading zero. |
| | | 128~255 is reserved for protocol extension. |
| Len | 2 bytes | The byte length of this transfer. The length includes |
| | | Cmd, Len and all Data parts in this command, but does |
| | | not include any Cnt or the zeros part. Low byte |
| | | first. 3~65535. |
| Data | Variable | Data of this command. 0 bytes minimum. 65532 bytes |
| | bytes | Maximum. |
| Zeros | Variable | 0s added at the end of the last packet to make all |
| | bytes | packet 8-byte length. 0 bytes minimum. 6 bytes |
| | | maximum. |

Every command transaction is preferably followed by one Device to Host Data Transfer at the minimum acknowledge receipt and validation of the transmitted Host Data to Device transfer.

Device to Host Data Transfer

The device sends data to the host as a response to the host command. Data transferring from the device to the host is through USB Interrupt In Report.

Packet Level
Same as Host to Device Transfer, a Device to Host Transfer resides
in one or more USB Data Packet. Each Data Packet is 8-byte long.

| Cnt | 1 byte | Bit 7 | Reset |
|---|---|---|---|
| | | | 0 Continued packet to the previous packet in |
| | | | a transfer or |
| | | | 1 First packet in a transfer |
| | | Bit 6-0 | 7-bit counter. Reference to as described above |
| | | | under Host to Device Data Transfer. |
| | | | As a response to a previous Host to Device |
| | | | Transfer, the counter in the first packet sent by |
| | | | the Device is one more than that of the |
| | | | previous packet sent by the Host with |
| | | | Reset bit has a value of 1. |
| | | | 0-127 |

Command Level (FIG. 8)

| | | |
|---|---|---|
| cAck | 1 bytes | If command was valid cAck = 30 (ASCII char ‘0’) |
| | | If the command was not valid/acted on, a value should |
| | | be between 31 and 39 Command code. |
| | | 0 Reserved for heading zeros |
| | | 1-127 Acknowledge code |
| | | 128-255 Reserved for protocol extension |
| Len | 2 bytes | The byte length of this transfer. The length includes |
| | | Cmd, Len and all Data parts in this command, but does |
| | | not include any Cnt or the zeros part. Low byte |
| | | first. 3~65535. |
| Data | Variable | Data to transfer. 0 bytes minimum. 65532 bytes |
| | bytes | Maximum. |
| Zeros | Variable | 0s added at the end of the last packet to make all |
| | bytes | packet 8-byte length. 0 bytes minimum. 6 bytes |
| | | maximum. |

It can thus be seen that the present invention provides a portable IR thermometer having a USB-HID interface. While preferred embodiments of the invention have been shown and described, modifications and variations may be made thereto by those of ordinary skill in the art without departing from the spirit and scope of the present invention. In addition, it should be understood that aspects of the various embodiments may be interchanged both in whole or in part. Furthermore, those of ordinary skill in the art will appreciate that the foregoing description is by way of example only, and is not intended to be limitative of the invention as further described in the appended claims.

What is claimed is:

1. A portable noncontact thermometer comprising:
a hand-held housing defining an aperture for ingress of incident thermal energy from a target location;
a thermometer module including a noncontact thermal energy detector;
said thermometer module further including at least one microcontroller operative to interpret electrical signals derived from an output of said noncontact thermal energy detector so as to determine temperature at said target location;
a USB-HID communication interface operative to permit electrical communication between said at least one microcontroller and a remote computer; and
a display device fixed with respect to said housing.

2. A portable noncontact thermometer as set forth in claim 1, wherein said communication interface is capable of downloading information from said at least one microcontroller and uploading information to said at least one microcontroller.

3. A portable noncontact thermometer as set forth in claim 1, wherein said communication interface permits reprogramming of said at least one microcontroller.

4. A portable noncontact thermometer as set forth in claim 3, wherein said at least one microcontroller comprises a main microcontroller and an ADC microcontroller in communication with each other.

5. A portable noncontact thermometer as set forth in claim 4, wherein said ADC microcontroller is reprogrammed via main microcontroller.

6. A portable noncontact thermometer as set forth in claim 1, comprising a mini-USB port located on said housing, said mini-USB port being electrically connected to said communication interface.

7. A system comprising:
a portable noncontact thermometer having a USB-HID communication interface, said communication interface being operative to convert in and out reports pursuant to HID protocol; and
a remote computer having an operating system running a USB-HID driver so as to communicate with said thermometer via said communication interface.

8. A system as set forth in claim 7, further comprising software running on said computer for downloading temperature information from said noncontact thermometer to said computer.

9. A system as set forth in claim 7, further comprising software running on said computer for uploading emissivity data from said computer to said noncontact thermometer.

10. A system as set forth in claim 7, wherein said communication interface of said noncontact thermometer is operative to communicate with said remote computer via a wired connection.
